(19) United States
(12) Patent Application Publication
(10) Pub. No.: US 2023/0252544 A1
(43) Pub. Date: Aug. 10, 2023

(54) MACHINE LEARNING BASED PRODUCT CLASSIFICATION AND APPROVAL

(71) Applicant: Microsoft Technology Licensing, LLC, Redmond, WA (US)

(72) Inventors: Roman Merkulov, Dublin (IE); Victor Chien, San Francisco, CA (US); Armen E. Khodaverdian, Walnut Creek, CA (US); Saisaket Potluri, Campbell, CA (US); Deirdre Hogan, Dublin (IE); Dacheng Zhao, Palo Alto, CA (US)

(21) Appl. No.: 17/665,465

(22) Filed: Feb. 4, 2022

(51) Int. Cl. G06Q 30/06

(52) U.S. Cl. CPC G06Q 30/0625

(57) ABSTRACT

Technologies for machine learning-based product classification and approval are described. In some embodiments, a product data record is received and analyzed by machine learning models. The data record includes at least a product description, a product category, and a source organization. A first trained machine learning model is applied to the product description. The first trained machine learning model generates a product type. A second machine learning model is applied to the data record. The second machine learning model produces a classification that includes a confidence score. A decision rule is applied to the classification and the product type. An approval status is generated for the data record.

### TECHNICAL FIELD

The present disclosure generally relates to product classification and approval, and more specifically, relates to machine learning based product classifications and approvals.

### BACKGROUND

Online platforms, such as digital marketplaces, receive and distribute massive amounts of digital products, physical products, and services through digital listings and e-commerce portals. Product approval is the process of screening and verifying that product submissions are approved and categorized based on policies and guidelines of a particular online platform and to determine that product submissions correspond to actual products of the type specified in the submission.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system that includes a product approval system in accordance with some embodiments of the present disclosure.

FIG. 2 is an example of an approval flow for the product approval system in accordance with some embodiments of the present disclosure.

FIG. 3 is an example of a decision rule in accordance with some embodiments of the present disclosure.

FIG. 4 is a flow diagram of an example method of machine learning based product classification and approval in accordance with some embodiments of the present disclosure.

FIG. 5 is an example of inter-component flows for machine learning based product classification and approval in accordance with some embodiments of the present disclosure.

FIG. 6 is an example of a chart of machine learning based results in accordance with some embodiments of the present disclosure.

FIG. 7 is an example of a data record in accordance with some embodiments of the present disclosure.

FIG. 8 is a block diagram of an example computer system for implementing a product approval system in accordance with some aspects of the present disclosure.

### DETAILED DESCRIPTION

Review and approval of product submissions on a distributed online platform presented in multiple different geographic regions and multiple different languages around the world presents challenges of scale, proper categorization, and accurate verification. As the quantity of products available in online marketplaces increases on the distributed online platform, there is an increasing need for scalable and accurate product reviews.

Existing product approval systems have not been able to scale appropriately as the quantity and types of products continue to proliferate. In existing product approval systems, the processes by which products are categorized, reviewed, and approved by human approvers have become tedious, labor-intensive and error prone.

Existing product approval systems are limited in the ways in which the classification and approval process can be performed. These limitations can cause significant delays and classification errors. Delays and errors in the classification and approval tasks make it increasingly difficult for the product approval administrators to perform timely and accurate approval processes.

Existing systems rely entirely on the human reviewer to select the appropriate product classification, e.g., from a menu or list of available classifications. Consequently, if a product approver makes an error in determining if the product category is the most appropriate classification, there is no error correction available in the existing systems.

Additionally, certain types of products are very difficult for humans to consistently classify correctly. For example, certain software products can be classified into multiple different categories. In these circumstances, it is difficult for humans to consistently choose the same category for the same or similar software products due to the sheer number of available classifications from which the user is expected to select the correct one. This can cause the same or similar products to be listed in different portions of an online marketplace instead of being grouped together.

Moreover, because existing systems do not validate the product reviewer's selections for accuracy or consistency, misclassifications can cause products to be incorrectly approved for listing in an online marketplace. Incorrect or inappropriate listings affect the quality and reliability of the online marketplace.

Aspects of the present disclosure address the above and other deficiencies by providing machine learning based product classification and approval. Products as used herein refer to any type of products that can be listed for sale in an online marketplace, including software, digital assets, executable cloud software, graphics, images, or any combination of any of the foregoing.

Aspects of the present disclosure apply multiple machine learning models to data records that include a product description, a product category, and a source organization. Aspects include aggregating outputs of the multiple machine learning models, applying a decision rule to a classification and a product type, and generating an approval status for the data record.

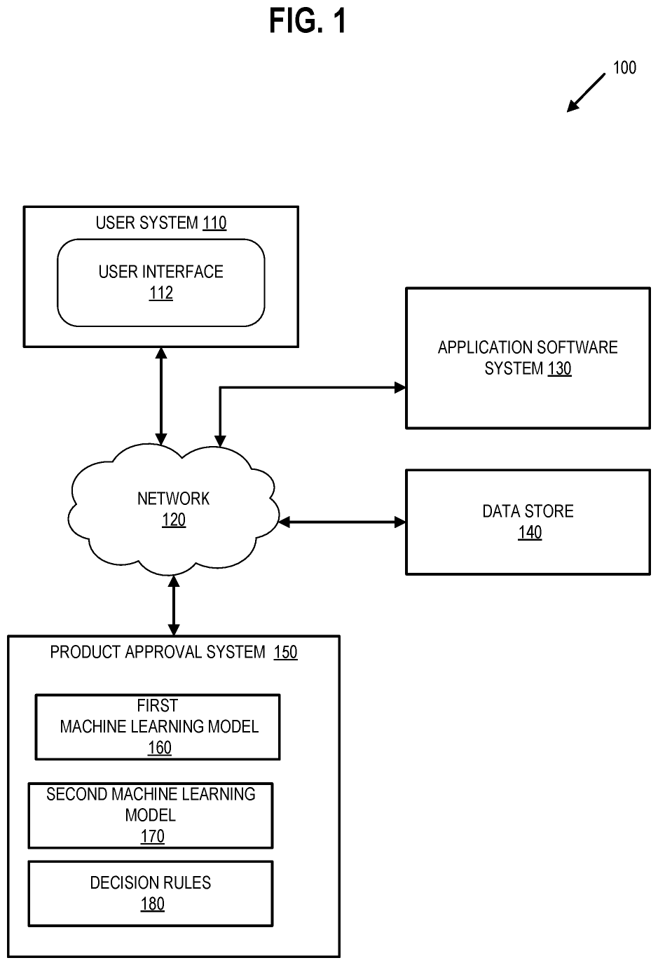

FIG. 1 illustrates an example of a computing system 100 that includes a product approval system 150 in accordance with some embodiments of the present disclosure.

Computing system 100 includes a user system 110, a network 120, an application software system 130, a data store 140, and a product approval system 150. Product approval system 150 includes a first machine learning model 160, a second machine learning model 170, and decision rules 180.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 includes a front-end portion of application software system 130.

User interface 112 is any type of user interface as described above. User interface 112 is used to input search queries and view or otherwise perceive output that includes data produced by application software system 130. For example, user interface 112 includes a graphical user interface and/or a conversational voice/speech interface that includes a mechanism for entering a search query and viewing query results and/or other digital content. Examples of user interface 112 include web browsers, command line interfaces, and mobile apps. User interface 112 as used herein includes application programming interfaces (APIs). In some embodiments, the user interface 112 is configured to receive input from a user and present data to the user. The user interface 112 receives inputs, such as from a user input device (not shown). For example, the user interface 112 presents data to the user requesting input, such as a moderation action. The user interface 112 presents various media elements to the user including audio, video, image, haptic, or other media data.

Data store 140 is a memory storage. Data store 140 stores product data, such as product data records created from product submissions, including product category data, product type data, source organization data, as well as machine learning model output such as product classification data. Data store 140 resides on at least one persistent and/or volatile storage device that resides within the same local network as at least one other device of computing system 100 and/or in a network that is remote relative to at least one other device of computing system 100. Thus, although depicted as being included in computing system 100, portions of data store 140 could be part of computing system 100 or accessed by computing system 100 over a network, such as network 120. For example, data store 140 could be part of a data storage system that includes multiple different types of data storage and/or a distributed data service. As used herein, data service could refer to a physical, geographic grouping of machines, a logical grouping of machines, or a single machine. For example, a data service could be a data center, a cluster, a group of clusters, or a machine.

Application software system 130 is any type of application software system that includes or utilizes functionality provided by product approval system 150. Examples of application software system 130 include but are not limited to digital commerce software, such as social media storefronts, and systems that are or are not based on digital commerce software, such as general-purpose software distribution platform, software repository, or software-as-a-service providers, or any combination of any of the foregoing.

While not specifically shown, it should be understood that any of user system 110, application software system 130, data store 140, product approval system 150, first machine learning model 160, second machine learning model 170, and decision rules 180 includes an interface embodied as computer programming code stored in computer memory that when executed causes a computing device to enable bidirectional communication with any other of user system 110, application software system 130, data store 140, product approval system 150, first machine learning model 160, second machine learning model 170, and decision rules 180 using a communicative coupling mechanism. Examples of communicative coupling mechanisms include network interfaces, inter-process communication (IPC) interfaces and application program interfaces (APIs).

A client portion of application software system 130 operates in user system 110, for example as a plugin or widget in a graphical user interface of a software application or as a web browser executing user interface 112. In an embodiment, a web browser transmits an HTTP request over a network (e.g., the Internet) in response to user input that is received through a user interface provided by the web application and displayed through the web browser. A server running application software system 130 and/or a server portion of application software system 130 receives the input, performs at least one operation using the input, and returns output using an HTTP response that the web browser receives and processes.

Each of user system 110, application software system 130, data store 140, product approval system 150, first machine learning model 160, and second machine learning model 170 is implemented using at least one computing device that is communicatively coupled to electronic communications network 120. Any of user system 110, application software system 130, data store 140, product approval system 150, first machine learning model 160, and second machine learning model 170 is bidirectionally communicatively coupled by network 120. User system 110 as well as one or more different user systems (not shown) could be bidirectionally communicatively coupled to application software system 130.

A typical user of user system 110 could be an administrator or end user of application software system 130, product approval system 150, first machine learning model 160, second machine learning model 170, and/or decision rules 180. User system 110 is configured to communicate bidirectionally with any of application software system 130, data store 140, product approval system 150, first machine learning model 160, second machine learning model 170, and/or decision rules 180 over network 120.

The features and functionality of user system 110, application software system 130, data store 140, product approval system 150, first machine learning model 160, second machine learning model 170, and/or decision rules 180 are implemented using computer software, hardware, or software and hardware, and includes combinations of automated functionality, data structures, and digital data, which are represented schematically in the figures. User system 110, application software system 130, data store 140, product approval system 150, first machine learning model 160, second machine learning model 170, and decision rules 180 are shown as separate elements in FIG. 1 for ease of discussion but the illustration is not meant to imply that separation of these elements is required. The illustrated systems, services, and data stores (or their functionality) could be divided over any number of physical systems, including a single physical computer system, and could communicate with each other in any appropriate manner.

Network 120 could be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

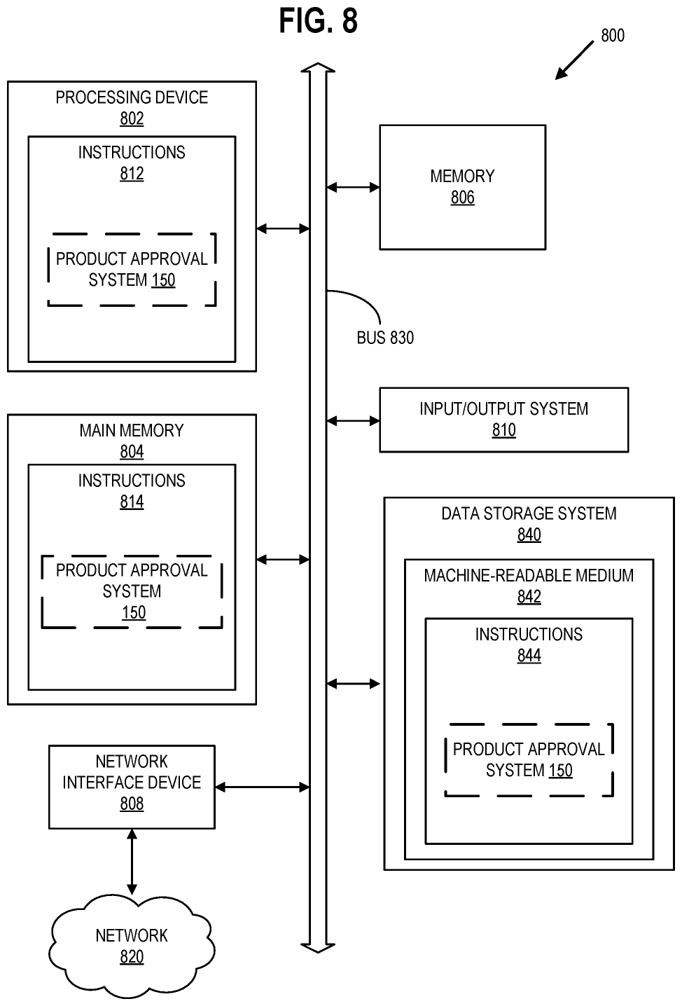

The computing system 100 includes a product approval system 150 that applies first machine learning model 160 and second machine learning model 170 to product submission data records to generate a product type and a classification including a confidence score for each data record. Computing system 100 uses the product type and classification including the confidence score to determine an approval status for the data record. In some embodiments, the application software system 130 includes at least a portion of the first machine learning model 160 and/or second machine learning model 170. As shown in FIG. 8, the product approval system 150 could be implemented as instructions stored in a memory, and a processing device 802 could be configured to execute the instructions stored in the memory to perform the operations described herein.

The product approval system 150 provides a machine learning based product approval process for an online platform. While product approval system 150 is described as an executable application, in some embodiments, the product approval system 150 could be implemented in specialized hardware or as a cloud Software or as a Service (SaaS) application. The disclosed technologies are described with reference to an example use case of automated product classification and approval; for example, generating an approval status for a data record, such as a product record that includes a product description, product category, and source organization. The disclosed technologies are not limited to product distribution networks but could be used to generate approval statuses based on machine learning models more generally. The disclosed technologies could be used by many different types of network-based applications in classifying data records that are created based on online submissions and are processed by one or more reviewing or approval entities. The product approval system 150 could perform the described functions in an offline (periodic processing of data records) or in an online (real-time or near real-time processing of data records) mode.

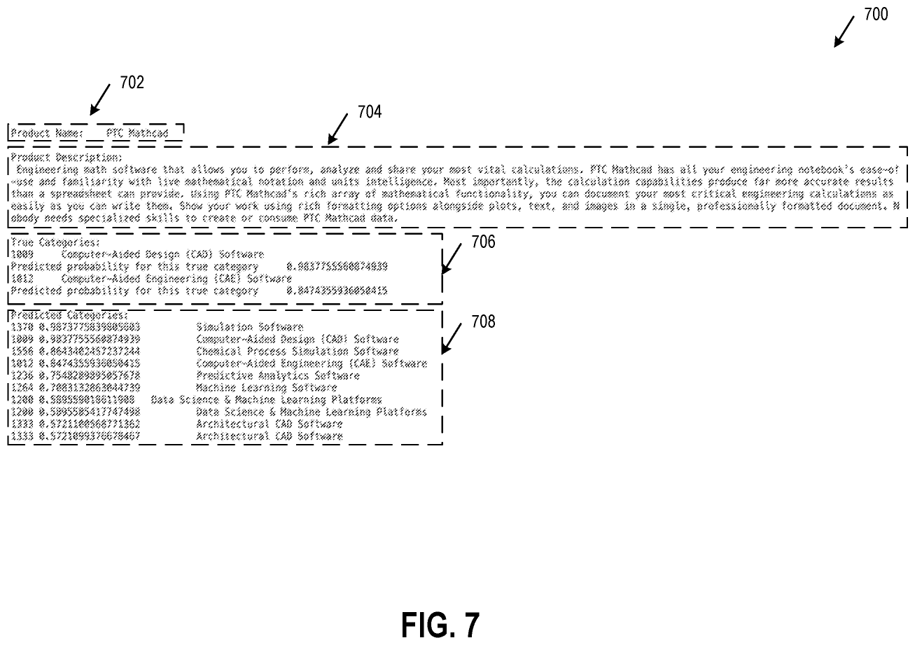

An example of a data record including a product description and the product category are text fields of variable length that include a textual description. The product description includes one or more words, characters, or other text that describes the product. An example of a product description is illustrated as product description 704 as depicted in the data record 700 of FIG. 7.

The product approval system 150 of FIG. 1 includes a first machine learning model 160, a second machine learning model 170, and decision rules 180. Some embodiments of first machine learning model 160 include one or more trained machine learning models for generating a product type from a product description that has been received through, for example, an online form. In some embodiments, the product description as well as other information, such as a product type and/or a source organization, are all part of a product submission that is created through the use of an online form. In other embodiments, the product type is not part of the product submission but is generated by the first machine learning model based on other information in the product submission. In still other embodiments, the product type is included as part of the product submission but the first machine learning model is still used to generate a product type based on other information in that same submission. In this way, the machine learning based system is able to verify or validate the product type contained in the product submission received through the online form.

The product approval system 150 includes the first machine learning model 160 to generate a product type from the product description that has been submitted through an online form, in some embodiments. For instance, the first machine learning model 160 extracts natural language features from the product description and a product category. Examples of the product description and the product category are text fields of variable length that each include a textual description. The product description includes one or more words, characters, or other text that describes the product. An example of a product description is illustrated as product description 704 as depicted in FIG. 7. In some embodiments, the first machine learning model 160 extracts features from the product description, such as by tokenizing sets of characters included in the product description. The first machine learning model 160 determines a product type based on the extracted features. Examples of product types that can be determined by the first machine learning model 160 include a software product, a physical product, a service offering, or a combination of a product and a service (e.g., a software product with customer support service).

Some embodiments of the second machine learning model 170 include one or more trained machine learning models for producing a classification of the product that includes a confidence score based on the product type, the product description, and the source organization.

The product approval system 150 includes the second machine learning model 170 to produce a classification that includes a confidence score based on the product type, the product description, and the source organization, in some embodiments. For instance, the second machine learning model 170 is a trained classifier that receives the product type, product description and source organization. In some embodiments, the product type that is input to the second machine learning model is the product type that has been generated by the first machine learning model.

The second machine learning model 170 produces a classification that includes a confidence score. The classification indicates a category of the data record. For example, the second machine learning model 170 determines that the data record corresponds to a particular classification of a software product that is a simulation software, a computer-aided design software, or a predictive analytics software. That is, the classification is a finer-grain characterization of the product than the product type, in some embodiments. In other words, the product type and classification are categories at different levels of abstraction, which are determined by the first machine learning model 160 and the second machine learning model 170, respectively.

The second machine learning model 170 assigns a confidence score to each classification.

In some embodiments, additional machine learning models could be implemented. For example, additional machine learning models could be trained to predict classifications or product types based on industry of the source organization, a set of historical data records submitted by the user, a location of the user, and/or other attributes.

The product approval system 150 applies one or more of decision rules 180 to the data record to generate an approval status. The decision rules 180 include one or more conditions that are tested to determine an approval status of the data record. While described as separate decision rules, it should be understood that any combination of rules described could be integrated into a single decision rule. In some embodiments, the decision rules 180 are predetermined for a group of data records that are stored in data store 140 or received from user system 110. In other embodiments, the decision rules 180 are configured to be updated by the product approval system 150 at a time interval based on a number of data records received, an approval rate of data records processed, or other factors.

In one example, the decision rules 180 include a first condition that determines if the product type is an authorized product type. The decision rules 180 are configured to filter specific product types that are approvable for the product approval system 150. The decision rules 180 are configurable during an initialization of the product approval system 150 or dynamically during execution of the product approval system 150. In an example, the product approval system 150 is configured to provide automated approval for software products. A typical software product is a set of processor instructions that causes a processor to perform a task including a program, procedure, or routine. The product approval system 150 applies the decision rules 180 to compare an authorized product type (i.e., software product) to the product type included in the data record.

The decision rules 180 include a second condition that determines whether the product type generated by the first machine learning model 160 has a confidence value greater than a threshold confidence. In some embodiments, the second condition identifies an error in the data record that was input by the user. For instance, the second condition determines that the product type generated by the first machine learning model is different than the product type of the data record. The second condition outputs a flag that indicates that the data record contains an error that requires additional review.

The decision rules 180 include a third condition that determines whether one or more of the classifications produced by the second machine learning model 170 correspond to the product category of the data record. The decision rules 180 compare the product category included in the data record and compare to each classification produced by the second machine learning model 170. The product approval system 150 determines one or more matches between the classifications and the product category. In some embodiments the classification includes one or more subclassifications such as “software application, sales support, customer relationship management.” The product approval system 150 determines matches between any of the classification or subclassifications and the product category.

The product approval system 150 aggregates the results of applying each of the decision rules 180 to the output of the first machine learning model 160 and the second machine learning model 170. The product approval system 150 determines an approval status based on the aggregation of the results of the decision rules 180. In some examples, the product approval system 150 determines that the data record is approved. In other examples, the product approval system 150 determines that more information is required, such as flagging the data record for additional review. In yet other examples, the product approval system 150 disapproves the data record.

In some embodiments, the product approval system 150 stores an approval status for the data record in data store 140. The product approval system 150 stores metadata associated with the data record in the data store 140 that is used to identify duplicate data records.

Further details with regards to the decision rules and operations of the machine learning models are described below.

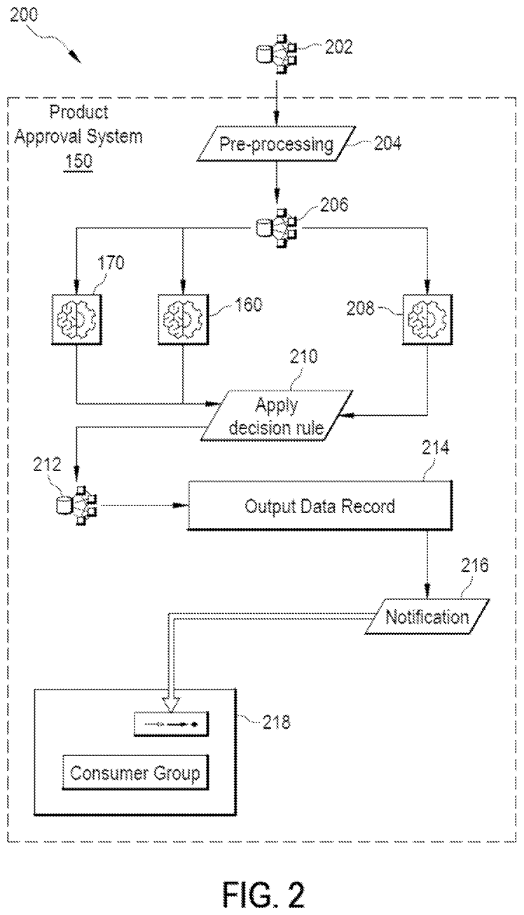

FIG. 2 is an example of process approval flow for the product approval system in accordance with some embodiments of the present disclosure.

A data record 202 is received by the product approval system 150. The data record 202 includes a product description, product category, and source organization. The product approval system 150 performs pre-processing 204 to the data record 202. In some embodiments, the pre-processing 204 includes feature extraction, data validation, data cleaning, and other pre-processing steps applicable to machine learning such as, but not limited to: Term Frequency-Inverse Document Frequency (TF-IDF), computing word embeddings, topic models, or count vectors. The pre-processing 204 outputs a prepared dataset 206. The product approval system 150 applies one or more machine learning models to the prepared dataset 206.

In some embodiments, the product approval system 150 applies first machine learning model 160 to the prepared dataset 206. The first machine learning model 160 is trained to extract features from text (or text features) of a product description and product category. The first machine learning model 160 identifies one or more words, characters, or other text features of the product description or product category. In one example, a product description 704 is illustrated as depicted in FIG. 7. The first machine learning model 160 extracts features from the product description 704, such as by categorizing or tagging the words, characters, or other text features of the product description 704. The first machine learning model 160 determines a product type based on the extracted features.

The first machine learning model 160 could be trained using supervised learning, unsupervised learning, or semi-supervised learning. For example, the first machine learning model could be any type of machine learning model such as a transformer-based model (e.g., BERT), a linear classifier, support vector machine, or deep neural network. The first machine learning model predicts a product type as a software product, physical product, service, or other type of product.

In some embodiments, the product approval system 150 applies second machine learning model 170 to the prepared dataset 206. The second machine learning model 170 is a trained classifier that receives prepared dataset 206. The second machine learning model 170 produces a one or more classifications, such as predicted categories of the prepared dataset 206. Examples of classifications are classifications 708 that each includes a confidence score associated with the classification and prepared dataset 206. Each classification indicates a product category of the data record. The second machine learning model 170 outputs each classification and the confidence score.

Embodiments of the product approval system 150 include additional machine learning models as depicted by additional machine learning model 208. The product approval system 150 could include any number of machine learning models. In one example, the product approval system 150 includes the additional machine learning model 208 that is trained to generate a set of similar products from the data record. The additional machine learning model 208 receives the data record, historical data record of previous product approvals, a user profile associated with creation of the data record or the historical data record. The additional machine learning model 208 is configured to generate a set of similar products based on the data record and the historical data. In some embodiments, the additional machine learning model 208 is further configured to identify duplicate products by determining that a previous product approval has a similarity with the data record (including metadata) that is greater than a threshold similarity. The additional machine learning model 208 prevents duplication of product submissions and circumvents a user altering the product description, or product category.

At step 210, the product approval system 150 applies one or more decision rules to the outputs of the first machine learning model 160, the second machine learning model 170, and additional machine learning model 208. The decision rules 180 include a number of conditions that determine if the product type is approved for listing on an online platform based on the outputs of the first machine learning model 160, the second machine learning model 170, and, optionally, the additional machine learning model(s) 208. The decision rules are configurable during design of the product approval system 150 or dynamically during execution of the product approval system 150. In some embodiments, the decision rules are further configurable to apply to particular types or classifications of products. For example, one decision rule could apply to a software product to require a language of a webpage identified in the data record by a uniform resource link (URL) to match a language of a country associated with the source organization. In another example, a decision rule that applies to physical products could require a location of the source organization as included in the data record to meet jurisdictional or international trade requirements (e.g., certain types of physical products are not able to be offered outside of the country of the source organization).

The product approval system 150 assigns an approval status to the data record based on an aggregate of the outcomes of each of the decision rules as described above. The product approval system 150 annotates the data record to reflect the approval status in processed data record 212.

The product approval system 150 generates an output data record 214 including the approval status of the data record 202. The product approval system 150 includes one or more reasons for assigning the approval status in the output data record 214. Examples of the reasons include but are not limited to the product data record does not include a product, the data record 202 is determined as not an owner of the product, a confidence score that is less than a lowest acceptable threshold, or other reasons.

The product approval system 150 stores the output data record 214 in data store 140. In some embodiments, the product approval system 150 generates a notification 216 that indicates the approval status and the data record to which the approval status is associated. The product approval system 150 generates the notification 216 with a predefined schema that includes a model version, the reason for the approval status, and other data. The product approval system 150 communicates the notification 216 to a consumer group of devices and/or resources. Examples of the consumer group include a virtual machine, a cloud computing instance, or another system to consume the approval status and associated data record for downstream processing such as a KAFKA consumer group.

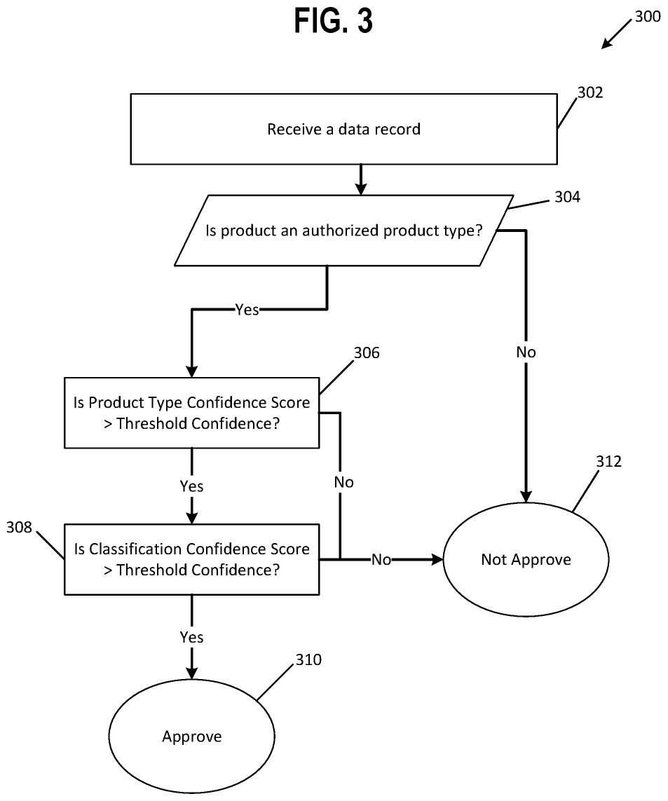

FIG. 3 is an example of a decision rule in accordance with some embodiments of the present disclosure. For instance, portions of the product approval system 150 are implemented as one or more software applications and/or specialized hardware. The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof In some embodiments, the method 300 is performed by portions of the product approval system 150 of FIG. 1.

Although shown in a particular sequence or order, unless otherwise specified, the order of the processes is configurable. Thus, the illustrated embodiments should be understood only as examples, and the illustrated processes could be performed in a different order, and some processes could be performed in parallel. Additionally, one or more processes could be omitted in various embodiments. Thus, not all processes are required in every embodiment. Other process flows are possible.

At operation 302, the processing device receives a data record. For example, a product approval system receives a data record from the application software system 130 via any communicative coupling mechanisms include network interfaces, inter-process communication (IPC) interfaces and application program interfaces (APIs). In some embodiments, the data record is received from user system 110 in response to a user selection. As described above, the data record includes, but is not limited to a product type, a product description, and a source organization.

At operation 304, the processing device determines whether a product described in the data record received at operation 304 is an authorized product type. The processing device compares the product type to a set of authorized product types. In some examples, the processing device determines that the product type of the data record is authorized and the method 300 proceeds to operation 306. In other examples, the processing device determines that the product type of the data record is not authorized and the method 300 proceeds to operation 312.

At operation 306, the processing device applies a first machine learning model to the product description of the data record. The first machine learning model generates a product type from the product description. For example, the first machine learning model performs one or more feature extractions of natural language features such as entity recognition, tokenization, stemming, lemmatization, or other segmentations to determine a primary content of the product description. The first machine learning model determines a product type such as a software product, a physical product, a service offering, or a combination of a product and service (e.g., a software product with customer support service) based on the natural language features.

Based on output of the first machine learning model, the processing device proceeds to either operation 308 or operation 312. The first machine learning model assigns a product type confidence score to each classification. In this example, the confidence score is a value between 0 and 1 that indicates a likelihood of the product type of the data record being in the assigned classification. When the product type confidence score is greater than a threshold product type confidence value, the processing device proceeds to operation 308. When the product type confidence score is less than or equal to the product type threshold confidence score, the processing device advances to operation 312.

At operation 308, the processing device applies a second machine learning model to the data record received at operation 302. For instance, the second machine learning model is a trained classifier that receives the product type, product description and source organization extracted from the data record. The second machine learning model produces one or more classifications that include a confidence score for each classification produced. Each classification indicates a predicted category of the data record.

Based on output of the second machine learning model, the processing device proceeds to either operation 310 or operation 312. The second machine learning model assigns a classification confidence score to each classification. In this example, the confidence score is a value between 0 and 1 that indicates a likelihood of the product category of the data record being in the assigned classification. When the classification confidence score is greater than a threshold classification confidence value, the processing device proceeds to operation 310. When the classification confidence score is less than or equal to the threshold classification confidence score, the processing device advances to operation 312. For example, the second machine learning model determines that the data record received at operation 302 corresponds to classification of a service offering that is consulting, a customer support service, or an internet technology maintenance service.

In this way, the processing device performs two different machine learning-based classification steps with two different trained machine learning models. In the first step, a first machine learning model is used to verify the product type classification of the data record. In the second step, a second machine learning model is used to determine a product category classification of the data record. The order of performance of these steps is reversed, in some embodiments. For example, the product category classification is performed before the product type classification, in some embodiments. In other embodiments, the product type classification and product category classification are performed concurrently or in parallel.

At operation 310, the processing device assigns the data record an approval status indicating that the data record is approved. For example, the processing device annotates, such as by updating a metadata attribute of the data record to an approved status.

At operation 312, the processing device assigns the data record an approval status of denied or requiring additional approval processes. For example, the product approval system could annotate, such as by updating a metadata attribute of the data record to an inconclusive or denied status. In some examples, the product approval system returns the product approval to the user that submitted the product with a request for additional information or corrections. In other examples, the product approval system determines that the data record receives a denied status. The product approval system is configured to notify the user or source organization of the denial. The product approval system is configured to store the outcomes of denial, inconclusive, or approved after corrections in the data store.

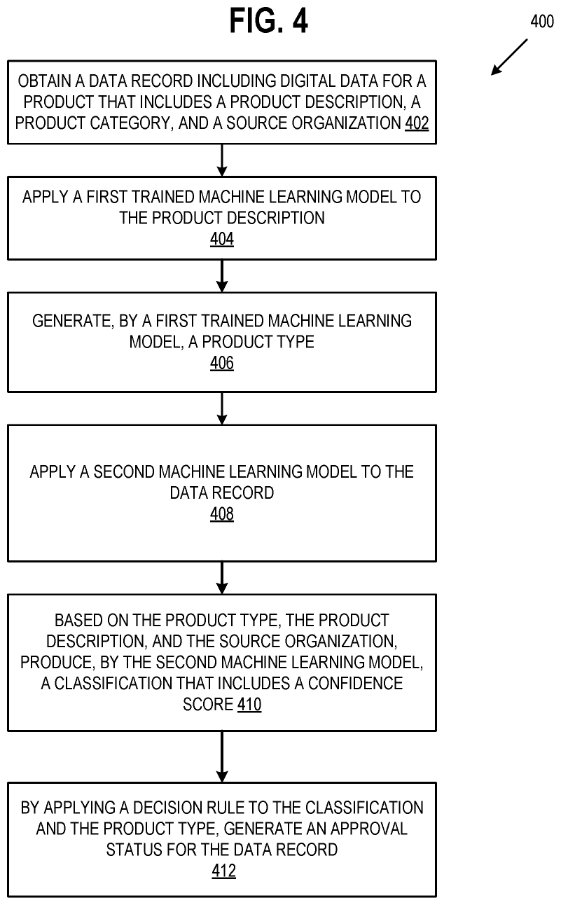

FIG. 4 is a flow diagram of an example method 400 of machine learning based product classification and approval in accordance with some embodiments of the present disclosure.

The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof In some embodiments, the method 400 is performed by portions of the product approval system 150 of FIG. 1.

Although shown in a particular sequence or order, unless otherwise specified, the order of the processes could be modified. Thus, the illustrated embodiments should be understood only as examples, and the illustrated processes could be performed in a different order, and some processes could be performed in parallel. Additionally, one or more processes could be omitted in various embodiments. Thus, not all processes are required in every embodiment. Other process flows are possible.

At operation 402, the processing device obtains a data record comprising digital data for a product that includes a product description, a product category, and a source organization. For example, a product approval system receives a data record from the application software system 130 via any communicative coupling mechanisms include network interfaces, inter-process communication (IPC) interfaces and application program interfaces (APIs).

At operation 404, the processing device applies a first trained machine learning model to the product description. The first machine learning model receives an input from the product description of the data record. The first machine learning model could be trained using one or more machine learning processes as described above. For example, the first trained machine learning model features from the text of the product description. The first trained machine learning model the features from text to categorize or label words, characters, or other text features of the product description.

At operation 406, the processing device generates, by a first trained machine learning model, a product type. For example, the first trained machine learning model determines a product type based on the features extracted at operation 404. The first machine learning model determines a product type such as a software product, a physical product, a service offering, or a combination of a product and service (e.g., a software product with customer support service).

At operation 408, the processing device applies a second machine learning model to the data record. The second machine learning model is a trained classifier that receives the data record. The second machine learning model generates one or more classifications, such as predicted categories of the data record.

At operation 410, the processing device produces, by the second machine learning model, a classification that includes a confidence score based on the product type, the product description, and the source organization. The second machine learning model generates a confidence score for each classification. The confidence score indicates a likelihood (e.g., a probability) of the data record being a product associated with the classification (e.g., sales software, tech support software, financial software).

At operation 412, the processing device generates an approval status for the data record by applying a decision rule to the classification and the product type. For example, the product approval system could annotate, such as by updating a metadata attribute of the data record to an approved status, a denied status, or a requiring additional information status. The product approval system is configured to notify the user or source organization of the completion of the product approval and the status of the data record. The product approval system is configured to store the outcomes of denial, inconclusive, or re-processed after inconclusive in the data store. In some embodiments, the processing device generates a notification that identifies an error such as a mismatch in the data record that was input by the user and the classification generated by the second machine learning model. For instance, the processing device notifies the user that an inaccurate product type was provided.

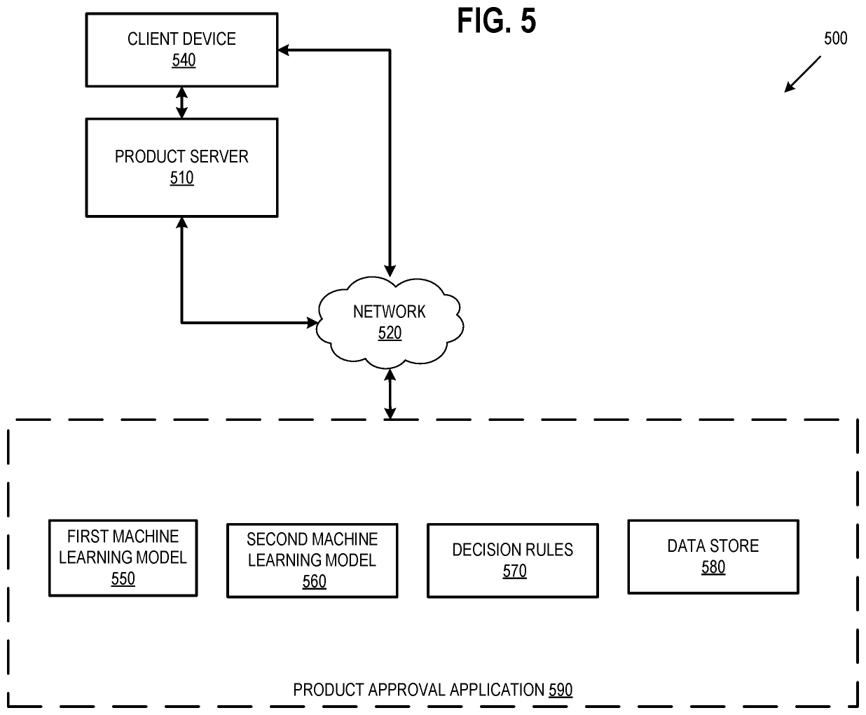

FIG. 5 is an example of inter-component flow of computing system in accordance with some embodiments of the present disclosure. The computing system 100 includes a client device 540, a product server 510, a network 520, and a product approval application 590 that includes a first machine learning model 550, a second machine learning model 560, decision rules 570, and a data store 580.

The client device 540 is any computing device, such as a personal computing device, a server, a mobile computing device, or a smart appliance. The client device 540 presents a graphical user interface to a user with access to the product server 510. The client device 540 receives input from the user of the client device. The client device 540 communicates the received input from the user to the product server 510. The client device 540 submits data records to product server 510 for machine learning based approval. The client device 540 receives an input data record from the user that includes a product name, product description, product type, source organization, and other metadata relating to the product.

The product server 510 is one or more computing devices that allows access to a set of approved products or services. The product server 510 is a centralized or distributed computing system and provides access to any type of digital media including images, contact information, software files, interactive services, etc. The product server 510 provides the set of approved products or services to multiple users with varying access types, including general users, administrative role users, and moderators.

The network 520 is implemented on any medium or mechanism that provides for the exchange of data, signals, and/or instructions between the various components of media moderation system 500. Examples of network 520 include a LAN, a WAN, an Ethernet network, an Internet Protocol (IP), Transmission Control Protocol (TCP), a satellite or wireless link, or a combination of any number of different networks and/or communication links.

The product approval application 590 includes multiple software applications and databases, including the first machine learning model 550, second machine learning model 560, decision rules 570, and data store 580.

The first machine learning model 550 is trained to extract features from text (or text features) of a product description and product category. The first machine learning model 160 determines a product type based on the extracted features.

For instance, the first machine learning model 550 is trained to extract features from text (or text features) of a product description and product category. The first machine learning model 550 could be a pre-trained sentence transformer or a neural network. The first machine learning model that is trained on a corpus of labeled product descriptions and product types.

The second machine learning model 560 is a trained classifier that produces a classification that includes a confidence score. The second machine learning model 560 is trained on a set of nodes that each represent a product category. For instance, the second machine learning model 560 is trainable on a classification hierarchy that includes classifications and subclassifications.

The decision rules 570 are a set of rules that include one or more conditions that are tested to determine an approval status of the data record. In some examples, the decision rules 570 are combinable into iterative loops, nested decision, decision trees, or a similar flow. In other examples, the decision rules 570 are executable in parallel.

The data store 580 is a data storage system that includes any number of types of data storage and/or a distributed data service. For example, the data store 580 is a physical, geographic grouping of machines, a logical grouping of machines, a single machine, a data center, a cluster, or a group of clusters.

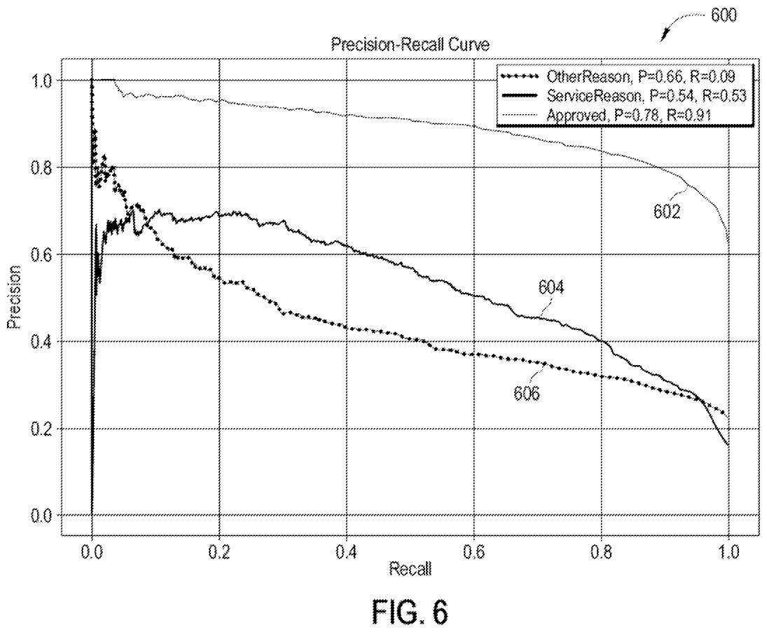

FIG. 6 is an example of a chart of machine learning results in accordance with some embodiments of the present disclosure. The chart 600 includes a first curve 602, a second curve 604, and a third curve 606. The first curve 602 depicts an example of a precision-recall curve of model performance associated with data records approved for a model that approves software products. The first curve 602 illustrates the relationship between precision and recall at various threshold values for data records that have approval status indicated approved. The second curve 604 depicts a precision-recall curve of model performance associated with data records that indicate the product type is a “service.” The third curve 606 depicts a precision-recall curve of model performance associated with data records that indicate that the approval status is not approved, but is not due to the product type of “service.” In some embodiments, the precision-recall curve are used to determine a threshold to be applied by any of the models that approve products.

FIG. 7 is an example of a training data record 700 in accordance with some embodiments of the present disclosure. The training data record 700 includes a product name 702, a product description 704, a set of true classifications 706, and a set of classifications 708. In this example, the true classifications 706 indicate that training data record 700 is labeled (such as for training data) to indicate the ground truth classifications to which training data record 700 should be classified. As described above, the second machine learning model generates classifications, such as classifications 708 from the data record 700. During training of the second machine learning model, the classifications 708 are compared with the true classifications 706 to adjust machine learning model parameters as the classifications are learned. While training data record 700 is described in a context of training, the training product name 702 and training product description 704 represent similar portions of a data record as described with regards to FIGS. 1-6.

In the example of FIG. 7, product name 702 is a text string having a length L1 and product description 704 is a text string having a length L2, where L1 is a positive integer and L2 is a positive integer that is greater than L1. Also in the example of FIG. 7, the set of true classifications 706 includes multiple different product type classifications for the same data record, where each classification 706 includes a product type classification number or code (e.g., a four-digit integer), a classification name (e.g., a text string), and a product type confidence value or score (e.g., a value between 0 and 1) that indicates a likelihood that the product type classification is associated with the data record 700.

Additionally, in the example of FIG. 7, the set of classifications 708 includes multiple different product category classifications for the same data record, where each classification 706 includes a product category classification number or code that is different from the product type classification (e.g., a four-digit integer), a product category classification name (e.g., a text string) that is different from the product type name, and a product category confidence value or score (e.g., a value between 0 and 1) that is different than the product type confidence value and indicates a likelihood that the predicted product category is associated with the data record 700.

FIG. 8 illustrates an example machine of a computer system 800 within which a set of instructions, for causing the machine to perform any one or more of the methodologies discussed herein, could be executed. In some embodiments, the computer system 1000 corresponds to a component of a networked computer system (e.g., the computing system 100 of FIG. 1) that includes, is coupled to, or utilizes a machine to execute an operating system to perform operations corresponding to the product approval system 150 of FIG. 1.

The machine could be connected (e.g., networked) to other machines in a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine could be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random-access memory (DRAM) such as synchronous DRAM (SDRAM) or Rambus DRAM (RDRAM), etc.), a memory 806 (e.g., flash memory, static random-access memory (SRAM), etc.), an input/output system 810, and a data storage system 840, which communicate with each other via a bus 830.

The main memory 804 is configured to store instructions 814 for performing the operations and steps discussed herein. Instructions 814 include portions of product approval system 150 when those portions of product approval system 150 are stored in main memory 804. Thus, product approval system 150 is shown in dashed lines as part of instructions 814 to illustrate that portions of product approval system 150 could be stored in main memory 804. However, it is not required that product approval system 150 be embodied entirely in instructions 1014 at any given time and portions of product approval system 150 could be stored in other components of computer system 1000.

Processing device 802 represents one or more general-purpose processing devices such as a microprocessor, a central processing unit, or the like. More particularly, the processing device could be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 could be one or more special-purpose processing devices such as an application specific integrated circuit (ASIC), a field programmable gate array (FPGA), a digital signal processor (DSP), network processor, or the like. The processing device 802 is configured to execute instructions 812 for performing the operations and steps discussed herein.

Instructions 812 include portions of product approval system 150 when those portions of product approval system 150 are being executed by processing device 802. Thus, similar to the description above, product approval system 150 is shown in dashed lines as part of instructions 812 to illustrate that, at times, portions of product approval system 150 are executed by processing device 802. For example, when at least some portion of product approval system 150 is embodied in instructions to cause processing device 802 to perform the method(s) described above, some of those instructions could be read into processing device 802 (e.g., into an internal cache or other memory) from main memory 804 and/or data storage system 840. However, it is not required that all of product approval system 150 be included in instructions 812 at the same time and portions of product approval system 150 are stored in one or more other components of computer system 800 at other times, e.g., when one or more portions of product approval system 150 are not being executed by processing device 802.

The computer system 800 further includes a network interface device 808 to communicate over the network 820. Network interface device 808 provides a two-way data communication coupling to a network. For example, network interface device 808 could be an integrated-services digital network (ISDN) card, cable modem, satellite modem, or a modem to provide a data communication connection to a corresponding type of telephone line. As another example, network interface device 808 could be a local area network (LAN) card to provide a data communication connection to a compatible LAN. Wireless links could also be implemented. In any such implementation network interface device 808 sends and receives electrical, electromagnetic, or optical signals that carry digital data streams representing various types of information.

The network link provides data communication through at least one network to other data devices. For example, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system 800.

Computer system 800 sends messages and receives data, including program code, through the network(s) and network interface device 808. In the Internet example, a server transmits a requested code for an application program through the network interface device 808. The received code could be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 88 includes an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information includes voice commands, audio signals, geographic location information, and/or digital imagery, for example.

The data storage system 840 includes a machine-readable storage medium 842 (also known as a computer-readable medium) which is stored one or more sets of instructions 844 or software embodying any one or more of the methodologies or functions described herein. The instructions 844 also resides, completely or at least partially, within the main memory 804 and/or within the processing device 802 during execution thereof by the computer system 800, the main memory 804 and the processing device 802 also constituting machine-readable storage media.

In one embodiment, the instructions 826 include instructions to implement functionality corresponding to a solver-based media assignment application (e.g., the product approval system 150 of FIG. 1). Product approval system 150 is shown in dashed lines as part of instructions 844 to illustrate that, similar to the description above, portions of product approval system 150 could be stored in data storage system 840 alternatively or in addition to being stored within other components of computer system 800.

Dashed lines are used in FIG. 8 to indicate that it is not required that product approval system 150 be embodied entirely in instructions 812, 814, and 844 at the same time. In one example, portions of product approval system 150 are embodied in instructions 844, which are read into main memory 804 as instructions 814, and portions of instructions 814 are read into processing device 802 as instructions 812 for execution. In another example, some portions of product approval system 150 are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Illustrative examples of the technologies disclosed herein are provided below. An embodiment of the technologies could include any of the examples or a combination of the described below.

In an example 1, a method includes obtaining a data record comprising digital data for a product that includes a product description, a product category, and a source organization; applying a first trained machine learning model to the product description; generating, by a first trained machine learning model, a product type; applying a second trained machine learning model to the data record; based on the product type, the product description, and the source organization, producing, by the second trained machine learning model, a classification that includes a confidence score; and by applying a decision rule to the classification and the product type, generating an approval status for the data record. An example 2 includes the subject matter of example 1, the generating, by the decision rule, the approval status including setting the approval status to approved when the product category matches the product type. An example 3 include the subject matter of example 1 or example 2, the generating, by the decision rule, the approval status including setting the approval status to rejected when the product category does not match the classification. An example 4 including the subject matter of any of examples 1-3, the applying a first trained machine learning model includes extracting a plurality of natural language features from the product description and product category; and determining the product type based on the plurality of natural language features, wherein the product type is a product or a service. An example 5 including the subject matter of any of examples 1-4, further including identifying, by the first trained machine learning model, an error in the data record based on determining a mismatch between the product category and the product type. An example 6 including the subject matter of any of examples 1-5, the determining a mismatch between the classification and the product type including comparing the product category of the data record the product type generated by the first trained machine learning model. An example 7 including the subject matter of any of examples 1-6, the applying the second trained machine learning model including extracting a plurality of features from the data record; and determining one or more classifications of the data record based on the plurality of features, wherein each of the one or more classifications is a product category; and generating a confidence score associated with each of the one or more classifications. An example 8 including the subject matter of any of examples 1-7, the confidence score is a probability that the product category describes the data record. An example 9 including the subject matter of any of examples 1-8, further including applying an additional machine learning model to the data record, a historical data record associated with the source organization, and a user associated with creation of the data record; and updating the approval status based on an output of the additional machine learning model. An example 10 including the subject matter of any of examples 1-9, the decision rule including a set of comparisons that indicate an approval of the data record, wherein the set of comparisons include the digital data and outputs of the first trained machine learning model and the second trained machine learning model.

An example 11 a system includes a memory component; and a processing device, coupled to the memory component, configured to perform operations including obtaining a data record comprising digital data for a product that includes a product description, a product category, and a source organization; applying a first trained machine learning model to the product description; generating, by a first trained machine learning model, a product type; applying a second trained machine learning model to the data record; based on the product type, the product description, and the source organization, producing, by the second trained machine learning model, a classification that includes a confidence score; and by applying a decision rule to the classification and the product type, generating an approval status for the data record.

An example 12 including the subject matter of example 11, the generating, by applying the decision rule, the approval status comprises setting the approval status to approved when the confidence score is above a threshold score and the product category matches the classification. An example 13 including the subject matter of example 11 or example 12, the generating, by the decision rule, the approval status comprises setting the approval status to rejected when the confidence score is less than a threshold score and the product category does not match the classification. An example 14 including the subject matter of any of examples 11-13, the operation of applying a first trained machine learning model includes extracting a plurality of natural language features from the product description and product category; and determining the product type based on the plurality of natural language features, wherein the product type is a product or service. An example 15 including the subject matter of any of examples 11-14, further including identifying, by the first trained machine learning model, an error in the data record based on determining a mismatch between the product category and the product type. An example 16 including the subject matter of any of examples 11-15 the determining a mismatch between the classification and the product type comprises comparing the classification of the data record the product type generated by the first trained machine learning model. An example 17 including the subject matter of any of examples 11-16 the operation of applying the second trained machine learning model includes extracting a plurality of features from the data record; and determining one or more classifications of the data record based on the plurality of features, wherein each of the one or more classifications is a product category; generating a confidence score associated with each of the one or more classifications. An example 18 including the subject matter of any of examples 11-17 where the confidence score is a probability that the classification describes the data record. An example 19 including the subject matter of any of examples 11-18, the operations further including applying an additional machine learning model to the data record, a historical data record associated with the source organization, and a user associated with creation of the data record; and applying an additional decision rule to an output of the additional machine learning model. An example 20 including the subject matter of any of examples 11-19, where the decision rule comprises a set of comparisons that indicate an approval of the data record, wherein the set of comparisons include the digital data and outputs of the first trained machine learning model and the second trained machine learning model.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus could be specially constructed for the intended purposes, or include a general-purpose computer selectively activated or reconfigured by a computer program stored in the computer. For example, a computer system or other data processing system, such as the product approval system 150 could carry out the computer-implemented processes in response to its processor executing a computer program (e.g., a sequence of instructions) contained in a memory or other non-transitory machine-readable storage medium. Such a computer program could be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems could be used with programs in accordance with the teachings herein, or it proves convenient to construct a more specialized apparatus to perform the method. The structure for a variety of these systems will appear as set forth in the description below. In addition, the present disclosure is not described with reference to any particular programming language. It will be appreciated that a variety of programming languages could be used to implement the teachings of the disclosure as described herein.

The present disclosure could be provided as a computer program product, or software, which includes a machine-readable medium having stored thereon instructions, which could be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications could be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
obtaining a data record comprising digital data for a product that includes a product description, a product category, and a source organization;
applying a first trained machine learning model to the product description;
generating, by a first trained machine learning model, a product type;
applying a second trained machine learning model to the data record;
based on the product type, the product description, and the source organization, producing, by the second trained machine learning model, a classification that includes a confidence score; and
by applying a decision rule to the classification and the product type, generating an approval status for the data record.

2. The method of claim 1, wherein generating, by the decision rule, the approval status comprises setting the approval status to approved when the product category matches the product type.

3. The method of claim 1, wherein generating, by the decision rule, the approval status comprises setting the approval status to rejected when the product category does not match the classification.

4. The method of claim 1, wherein applying a first trained machine learning model comprises:
extracting a plurality of natural language features from the product description and product category; and
determining the product type based on the plurality of natural language features, wherein the product type is a product or a service.

5. The method of claim 1 further comprising identifying, by the first trained machine learning model, an error in the data record based on determining a mismatch between the product category and the product type.

6. The method of claim 5, wherein determining a mismatch between the classification and the product type comprises comparing the product category of the data record the product type generated by the first trained machine learning model.

7. The method of claim 1, wherein applying the second trained machine learning model comprises:
extracting a plurality of features from the data record;
determining one or more classifications of the data record based on the plurality of features, wherein each of the one or more classifications is a product category; and
generating a confidence score associated with each of the one or more classifications.

8. The method of claim 7, wherein the confidence score is a probability that the product category describes the data record.

9. The method of claim 1, further comprising:
applying an additional machine learning model to the data record, a historical data record associated with the source organization, and a user associated with creation of the data record; and
updating the approval status based on an output of the additional machine learning model.

10. The method of claim 1, wherein the decision rule comprises a set of comparisons that indicate an approval of the data record, wherein the set of comparisons include the digital data and outputs of the first trained machine learning model and the second trained machine learning model.

11. A system comprising:
a memory component; and
a processing device, coupled to the memory component, configured to perform operations comprising:
obtaining a data record comprising digital data for a product that includes a product description, a product category, and a source organization;
applying a first trained machine learning model to the product description;
generating, by a first trained machine learning model, a product type;
applying a second trained machine learning model to the data record;
based on the product type, the product description, and the source organization, producing, by the second trained machine learning model, a classification that includes a confidence score; and
by applying a decision rule to the classification and the product type, generating an approval status for the data record.

12. The system of claim 11, wherein an operation of generating, by applying the decision rule, the approval status comprises setting the approval status to approved when the confidence score is above a threshold score and the product category matches the classification.

13. The system of claim 11, wherein an operation of generating, by the decision rule, the approval status comprises setting the approval status to rejected when the confidence score is less than a threshold score and the product category does not match the classification.

14. The system of claim 11, wherein an operation of applying a first trained machine learning model comprises:
extracting a plurality of natural language features from the product description and product category; and
determining the product type based on the plurality of natural language features, wherein the product type is a product or service.

15. The system of claim 11, the operations further comprising identifying, by the first trained machine learning model, an error in the data record based on determining a mismatch between the product category and the product type.

16. The system of claim 15, wherein determining a mismatch between the classification and the product type comprises comparing the classification of the data record the product type generated by the first trained machine learning model.

17. The system of claim 11, wherein an operation of applying the second trained machine learning model comprises:
extracting a plurality of features from the data record; and
determining one or more classifications of the data record based on the plurality of features, wherein each of the one or more classifications is a product category;
generating a confidence score associated with each of the one or more classifications.

18. The system of claim 17, wherein the confidence score is a probability that the one or more classifications describe the data record.

19. The system of claim 11, the operations further comprising:
applying an additional machine learning model to the data record, a historical data record associated with the source organization, and a user associated with creation of the data record; and
applying an additional decision rule to an output of the additional machine learning model.

20. The system of claim 11, wherein the decision rule comprises a set of comparisons that indicate an approval of the data record, wherein the set of comparisons include the digital data and outputs of the first trained machine learning model and the second trained machine learning model.
